(19) United States
(12) Patent Application Publication
(10) Pub. No.: US 2010/0287415 A1
(43) Pub. Date: Nov. 11, 2010

(54) METHOD OF MAKING AN ENDURING UNIVERSAL TOOL FOR DEVELOPING EQUIPMENT TESTS AND TOOL FOR THE IMPLEMENTATION THEREOF

(75) Inventor: Jean-Pierre Melis, Gidy (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, NEUILLY-SUR-SEINE (FR)

(21) Appl. No.: 12/810,854

(22) PCT Filed: Dec. 24, 2008
(86) PCT No.: PCT/EP08/68295

§ 371 Date: Jun. 28, 2010

(30) Foreign Application Priority Data
Dec. 28, 2007 (FR) 07 09176

(51) Int. Cl. G06F 11/36

(52) U.S. Cl. 714/38; 714/E11.207

(57) ABSTRACT

An enduring universal tool for developing equipment tests includes a requirement specification function, a test design function, a library of generic commands, document generation engines and libraries to support the conversion of high-level test programs into low-level language.

The present invention relates to a method of making an enduring universal tool for developing equipment tests and to a tool for the implementation thereof.

The development of a test bench is related to the development of an operating system with its constraints, its problems of obsolescence and its requirements for traceability and reuse.

At the present time, test programs are developed without any requirement for a link between the test specification and the code.

This absence of a link gives rise to excess costs which the end customer can no longer bear at the present time and which arise:
in the development of the test programs (due to the workload involved in the successive iterations of specification, documentation and code)
in the maintenance of these programs to keep them operational (software updating, reuse, upstream downstream funding) and more generally in the maintenance of the test bench to keep it operational (where hardware obsolescence requires revisions in the specifications and therefore in the complete sequence),
while all work done in response to obsolescence (of both software and hardware), combined with aleck of funding, gives rise to costs which cannot be justified at the present time.

The object of the present invention is a method of making a test bench for developing a test program at the lowest possible cost. Another object of the invention is a test bench made by this method.

The method according to the invention is a method of making an enduring universal tool for developing equipment tests using a test bench, and it is characterized in that it includes the following steps, implemented with a test development tool having a computer, means of data input and display, and at least one memory:
an operator designs the various tasks and subtasks of the test program on a test bench which the tool stores in memory;
he inputs the specifications of the requirements of the test program;
he chooses the requirements of the scenario which is to be followed according to the test results;
if the operator has input the data for the tests, the tool automatically generates the documentation for the tests thus designed;
a development operator then describes the operating mode for each of the tests for which requirements have been formulated, using the commands provided by a library of generic commands for the tool;
the operator proceeds to design each elementary test;
the tool automatically generates an exportable the translated into an appropriate language for the test bench used for the tests.

The present invention will be made clearer by the detailed description of an embodiment, provided by way of non-limiting example and illustrated by the attached drawing, in which:

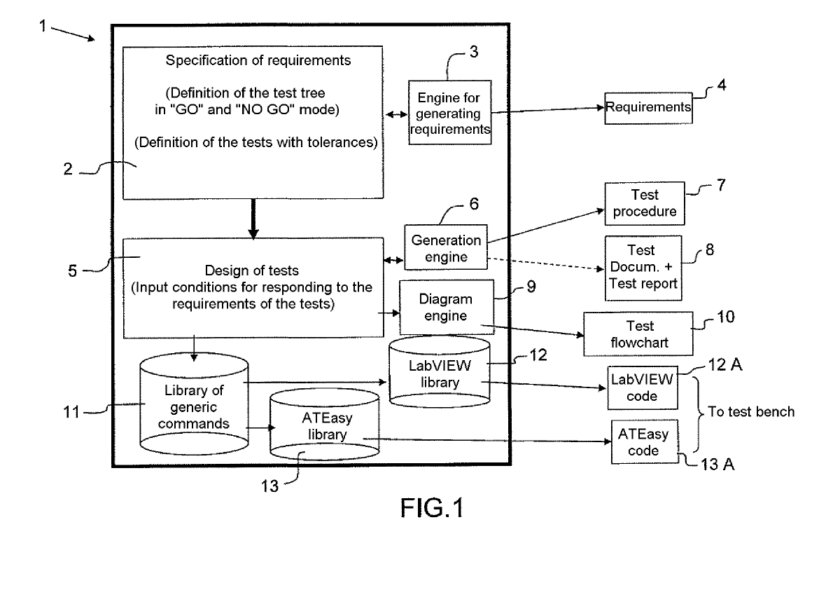

FIG. 1 is a block diagram of an exemplary embodiment of a test development tool implementing the method according to the invention;

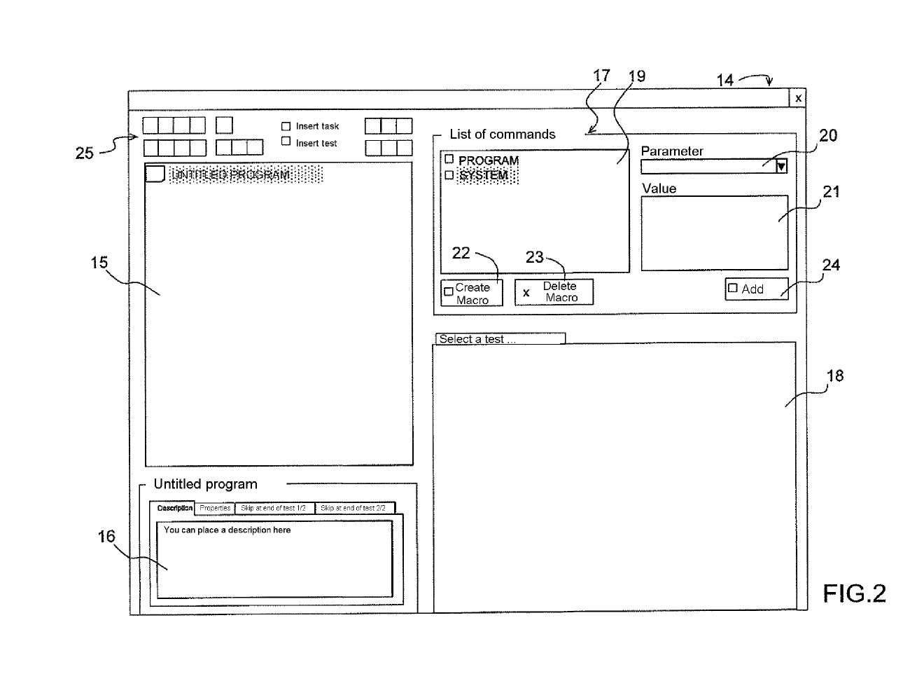

FIGS. 2 to 7 are examples of screen views taken at different stages of the implementation of the design steps of the method according to the present invention;

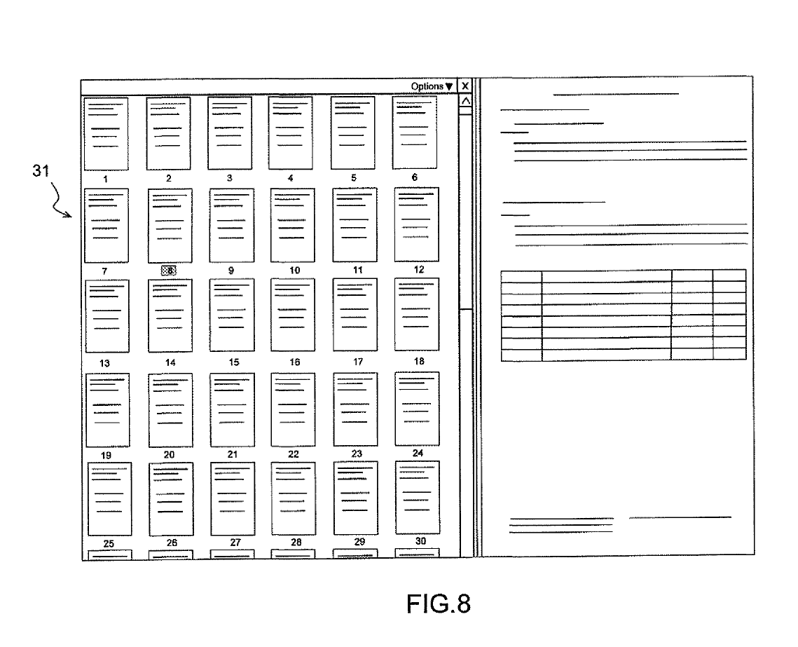

FIG. 8 is a screen view of an example of a document corresponding to the test requirements specification;

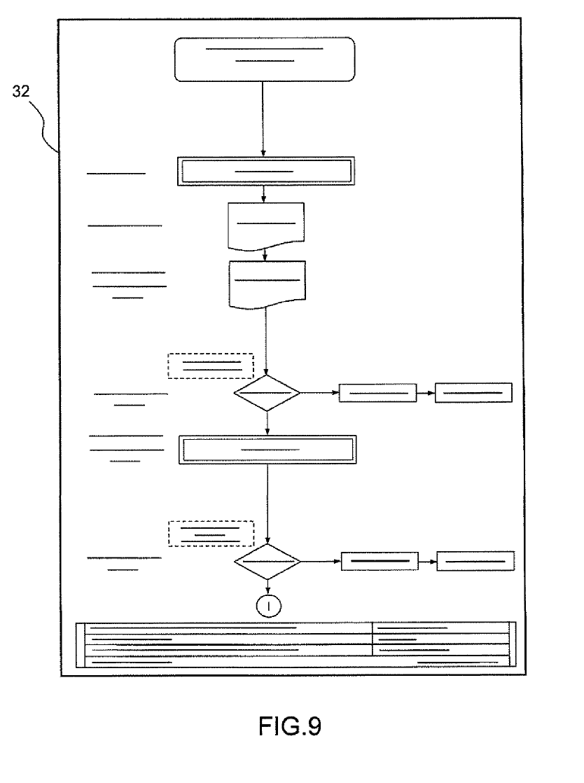

FIG. 9 is a screen view of an example of a test flowchart of the type which can be produced by the method according to the invention;

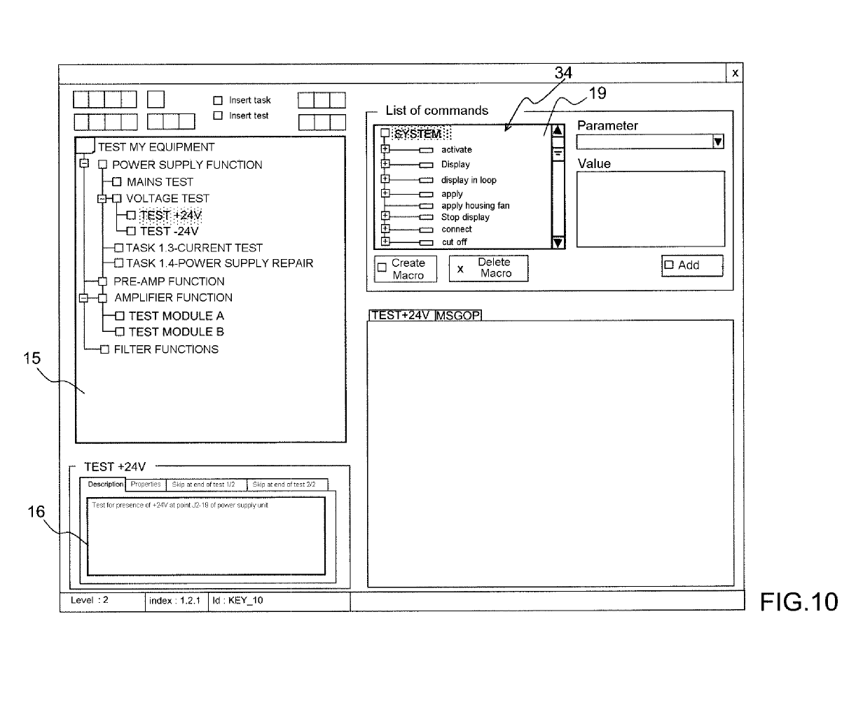

FIGS. 10 to 12 are examples of screen views taken at different stages of the implementation of the design steps of tests by the method according to the present invention; and

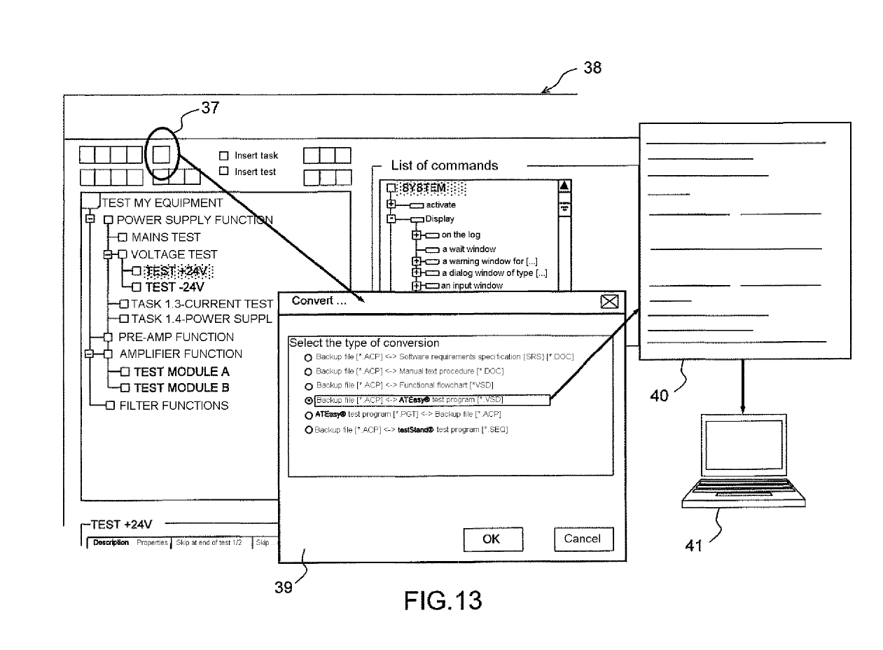

FIG. 13 is a diagram explaining the generation, by the method according to the invention, of a test code which can be used by a test bench.

The method according to the invention is essentially characterized by the provision of a tool which creates a real link between the test specification and the code, and it enables the phases of specification, design and coding of a test program to be optimized.

The block diagram of FIG. 1 shows schematically an exemplary embodiment of an enduring universal too 1 for developing equipment tests implementing the method according to the invention. This tool 1 has a data input function 2. This function is used to input the specifications of the requirements for the tests to be conducted, notably the definition of the test tree in “GO” and “NO GO” mode, that is to say in binary GOOD or BAD mode, and the definition of the tolerances applicable to the results of these tests. This function 2 is linked to an engine 3 for generating requirements which produces documentation relating to the specification of the software test requirements, this specification being in a special format (4), and it is followed by a test design function 5. The function 5 consists, notably, in defining input conditions allowing a response to be made to the requirements for the tests to be conducted. The implementation of functions 2 and 5 is explained in detail below with reference to FIGS. 2 to 7.

Function 5 is linked to a test generating engine 6 of a known type, which produces documentation 7 describing the test procedures designed with the aid of function 5, and, if necessary, documentation 8 describing the validation methods for the tests produced and documentation required for recording the results of this validation.

Function 5 is also linked to an engine 9 which produces a test flowchart 10, and it is linked to a pre-existing library 11 of generic commands. In turn, this library 11 is linked to libraries of specific languages. In the present case, two libraries of specific languages are used, for example the library 12 of the LabVIEW language which produces test codes 12A in LabVIEW® language, and the library 13 of the ATEasy® language which produces test codes 13A in ATEasy language, but clearly the tool 1 can have a single library of test language codes or one or more other libraries producing test program codes appropriate for the test benches used with the tool 1 according to the invention at the present time or in the future. This is because it must be possible to conduct tests on hardware throughout its service life, which may exceed 20 years, with test benches whose test programs are generally renewed or modified after a period of time which is markedly shorter than the service life of the hardware to be tested. The invention makes it possible to keep (in the memory of the computer of the tool 1 and/or on removable storage media) a trace of the test protocols and of the way in which they were designed, for a period at least as long as the period of use of the hardware to be tested. Because of the modular structure of the tool 1 (with the libraries 12 and 13 independent of the other functions of the tool 1), the tool can be adapted immediately to a new test language simply by changing the code library (such as the library 12 or 13).

FIGS. 2 to 7, described below, relate to screen views of a display terminal of a computer such as a microcomputer, which is used by an operator (who, in this first phase of specification of the requirements, is an expert on the hardware to be tested) to create the specifications of the requirements of the test program, and which incorporates the tool 1.

FIG. 2 shows a screen view 14 of the display which appears on the launch of the process of specification of the requirements (RSP) of the tool 1 (function 2). In the present example, this screen shows four different windows identified as 15 to 18, the window 17 having three sub-windows 19 to 21. These windows are, respectively, as follows:
Window 15: the main window for displaying the various tasks and subtasks of the test program to be used subsequently on a test bench, as they are designed. On the launch of the RSP program, this window contains only one initial line, reading “UNTITLED PROGRAM”, which is completed by a first operator who in this case is the operator responsible for specifying the requirements of the RSP process during the implementation of this process.
Window 16: initially entitled “UNTITLED PROGRAM”, like the single line of the window 15, and having four tabs in the present example, reading: “Description” (activated here), “Properties”, “Skip at end of test 112” and “Skip at end of test 212”. This window 16 contains the wording “You can place a description here”, to enable a description of the program to be input.
Window 17: entitled “List of commands”. It initially contains the following two lines in the sub-window 19: “PROGRAM” and “SYSTEM”. Its other two sub-windows 20 (“Parameter”) and 21 (“Value”) are initially blank. Window 17 also has three buttons, 22 to 24. These three buttons are entitled, respectively, “Create Macro”, “Delete Macro” and “Add”.
Window 18: this appears in the form of a tab, entitled “Select a test . . . ”. It is not activated initially, because no test exists as yet.

The view 14 also includes a set of buttons 25. This set of buttons has buttons showing conventional symbols such as “Open a file”, “Save”, “Close”, etc., together with some buttons which are specific to the invention, such as that used in the example shown in FIG. 13.

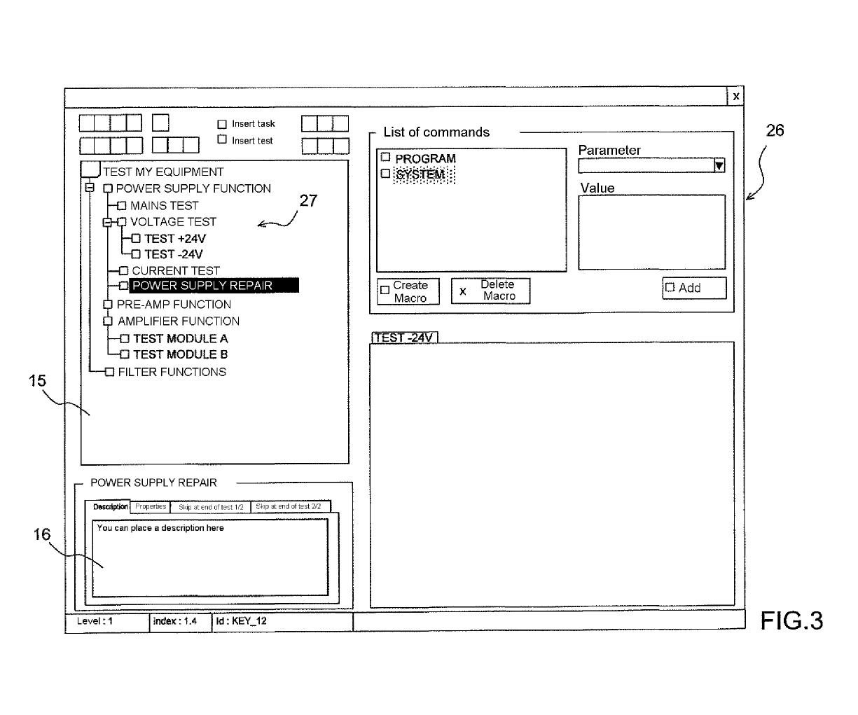

View 26 in FIG. 3 shows the start of the phase of inputting the tasks and subtasks of the RSP process. At this stage, data 27 has been input into window 15 only. The test program is now called “TEST MY EQUIPMENT”. This program includes a number of tasks, in this case called “POWER SUPPLY FUNCTION”, “PRE-AMP FUNCTION”, etc. These tasks are composed of subtasks. For example, the supply function includes subtasks such as “MAINS TEST”, “VOLTAGE TEST”, etc.

In this view 26, by way of example, the user has clicked on the sub-function “POWER SUPPLY REPAIR”, which is displayed in the title of window 16.

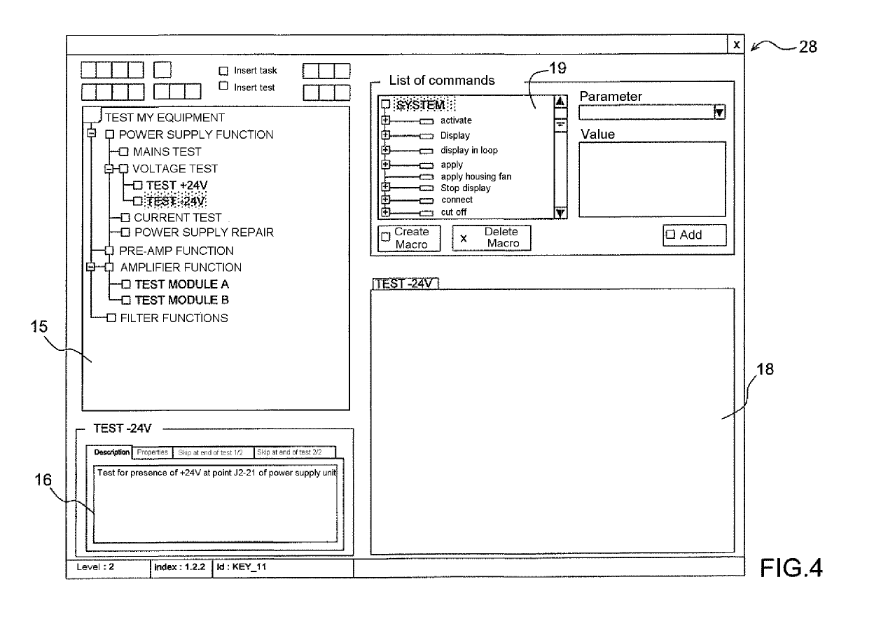

View 28 in FIG. 4 shows the details of a subtask. In this example, this subtask is “TEST −24V” which has been activated by clicking on the corresponding line of window 15. The name of this subtask is then displayed as the title of windows 16 and 18. Different commands which can be incorporated In “TEST −24V” are displayed In sub-window 19. Window 16 displays the description, edited by the operator, of the activated test in question.

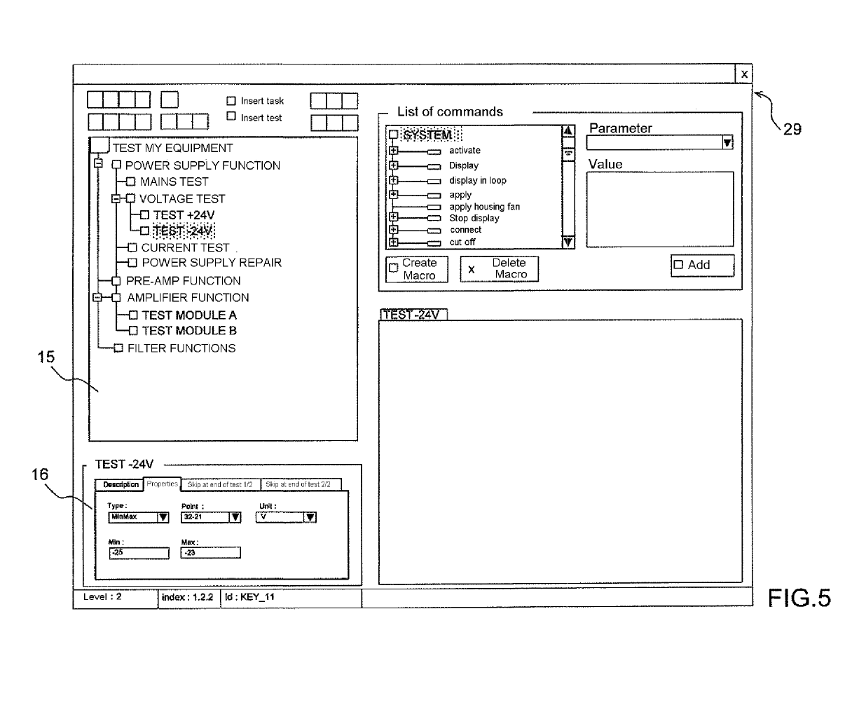

The first step in inputting the data, illustrated by view 29 in FIG. 5, is to have the operator input the associated requirements for each elementary test selected, such as the type of measurement, units of measurement, tolerances applicable to the measured values to determine their correctness, and the like. To do this, the operator activates the “Properties” tab of window 16 which, in the present example, relates to the “TEST −24V” test. In this example, the properties selected in sub-windows are “Min/max” for the type, “J2-21” for the name of the voltage measurement point, “V” (for volts) for the unit of measurement, −25 for the minimum acceptable value of measured voltage which will be recognized as satisfactory, and −23 for the maximum acceptable value. The bar shown at the bottom of the view of this FIG. 5 (and also in FIGS. 3 and 4 and FIGS. 6, 7, 10 and 11) provides complementary information such as the level of the test in the test program tree, the index associated with this test, the identity of the test, and the time.

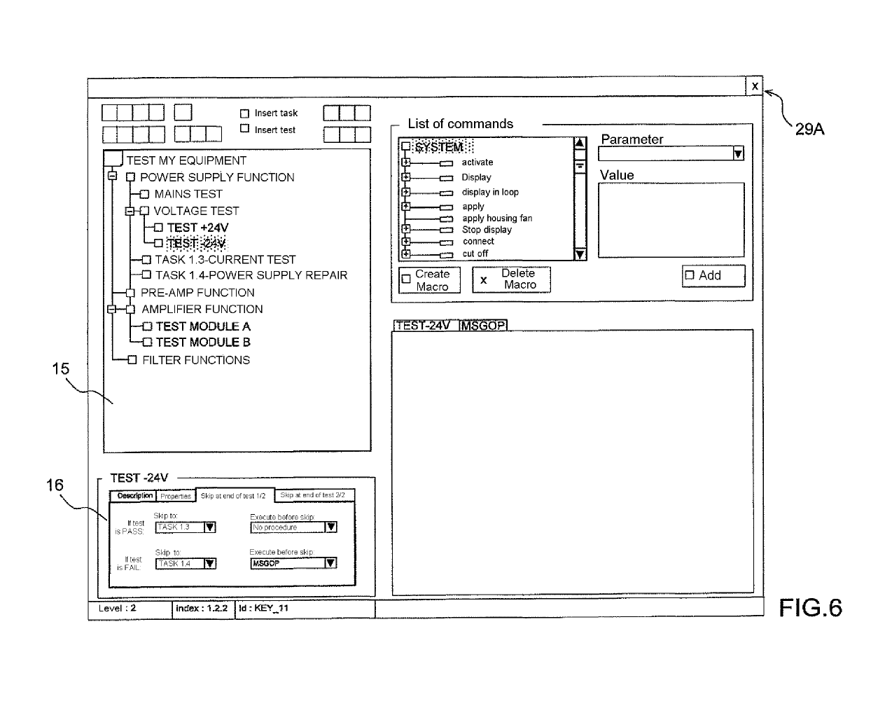

As shown in view 29A in FIG. 6, the operator then chooses the requirements of the scenario to be followed according to the test results, for each selected elementary test (which in this case is still the TEST −24V), in the present case, these results are either “PASS” or “FAIL”. The headings of these types of results appear in the activated tab marked “Skip at end of test 1/2” of window 16. For each of these types of result, two sub-windows, “Skip to” and “Execute before the skip”, are provided. Thus the operator can easily specify the rest of the test scenario regardless of the result of this elementary test, and can if necessary specify a special procedure (such as the “MSGOP” procedure as shown in the second sub-window of the “FAIL” result).

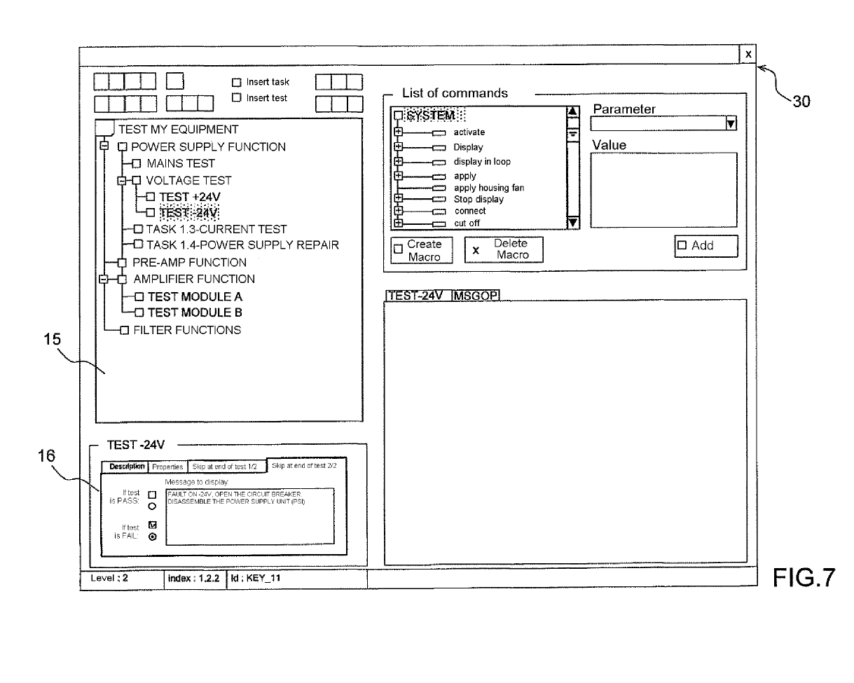

In a variant, as shown in view 301n FIG. 7, the input operator can cause a message to be displayed to the operator conducting the test in the window of the tab “Skip at end of test 2/2”, instead of indicating the rest of the scenario of this automatic program. In the example of FIG. 7, if the test fails, this message is “FAULT ON −24V. OPEN THE CIRCUIT BREAKER, DISASSEMBLE THE POWER SUPPLY UNIT (PS1)”.

When all the tasks and subtasks have been input in this way and the test and repair scenarios have been created, the tool 1 can automatically generate a document (a printed document, such as document 4 in FIG. 1, or a document displayed on a screen, such as that shown in FIG. 8) corresponding to the specification of the test requirements. This document is, for example, of the type shown partially in FIG. 8, or any other suitable type of document using the data input by the first operator. These other documents generated in this way are; for example, documents describing various phases of the design of the requirements, the validation procedures, and the like. The left-hand part of the view of FIG. 8 shows some of the first pages of the specification of the test requirements. The right-hand part of view 31 of FIG. 8 shows the detail of a page selected in the left-hand part, and in the present case page 8 has been selected.

FIG. 9 shows an example of a test scenario flowchart 32, such as that of document 101n FIG. 1.

When the test requirements have been formulated by the first operator, a development operator (who can be the first operator or a programmer) describes the operating mode for each of the tests whose requirements have been formulated by the first operator. To do this, he uses the commands supplied by the library of the tool, which is the library 11 of generic commands shown in FIG. 1. Sub-window 19 of view 33 of FIG. 10 shows some of the generic commands, which are available for all the tests, and in the present case those relating to the “TEST +24V” test have been shown and are identified by 34 in this drawing.

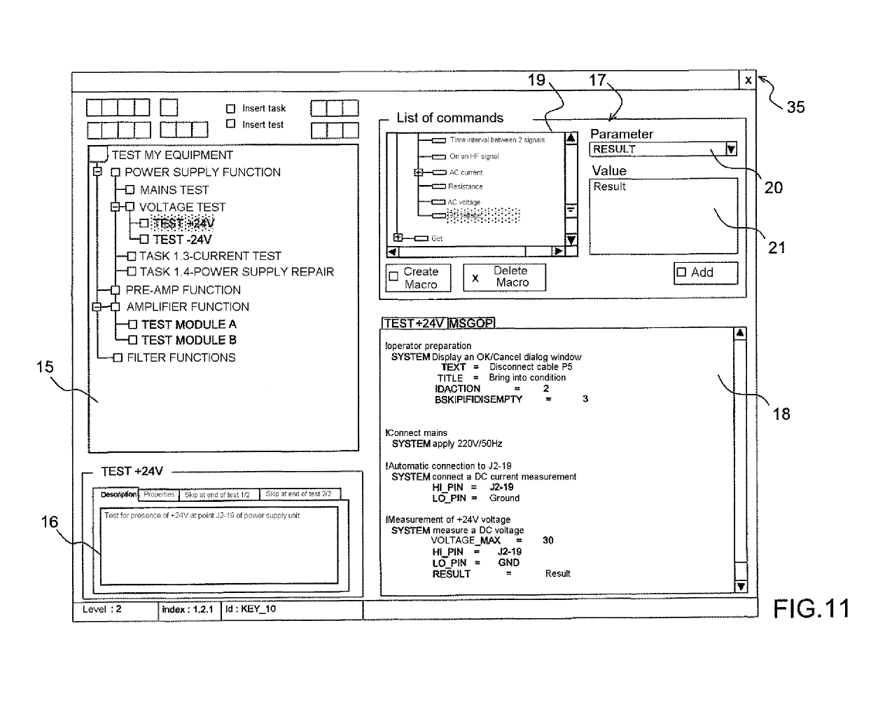

The operator uses these commands to design each elementary test. Thus; for the “TEST +24V” in question, the operator chooses the command “(measure) a DC voltage” from the sub-window 19 (view 35 of FIG. 11). Sub-windows 20 and 21 show the corresponding parameters for this command. In the illustrated example, this is the parameter for displaying the result of the measurement of the voltage (+24V). This parameter is simply named “RESULT” and its value is the variable “result” which represents the result of the measurement made by activating the DC voltage measurement subtask (appearing in window 19). Window 16 displays the corresponding comment “Test for presence of +24V at point J2-19 of the power supply unit” in the “Description” tab. The “TEST +24V” tab of window 18 displays, in “high level” language, the various lines of the corresponding program for which the headings of the routines visible in the drawing are, in succession, “Operator preparation” “Mains supply on”, “Automatic connection to J2-19” and “Measurement of +24V voltage”.

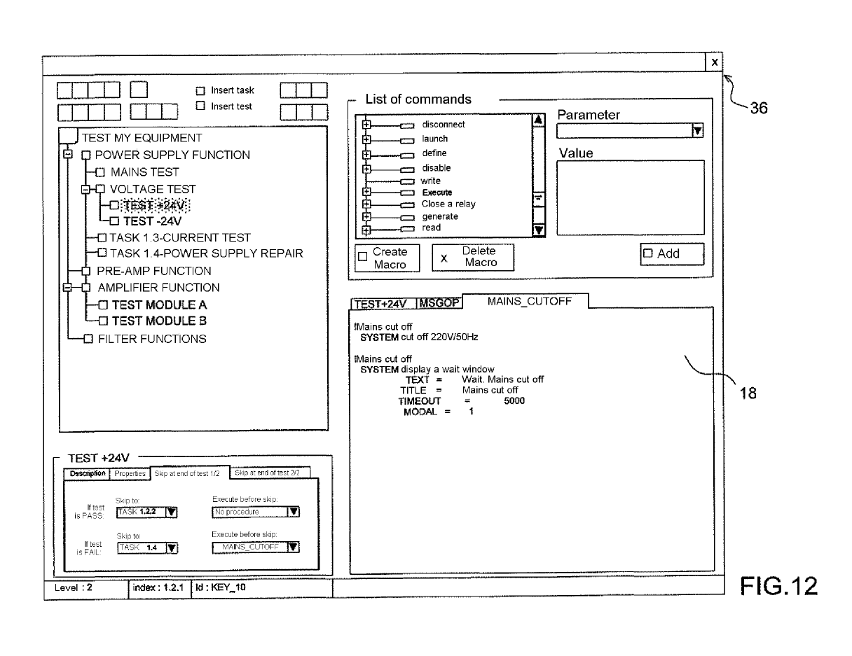

As shown in view 36 in FIG. 12, if operations have to be repeated the operator can create routines which can be called at any time. For the illustrated example, a routine (macro command) named “MAINS SUPPLY OFF”, which can be called several times during the design of the program, has been created for this purpose and can be accessed from a supplementary tab of window 18 named “MAINS SUPPLY OFF”. This routine appears when the operator cocks on this tab. This routine can be inserted into the program as follows:
either by an “execute a procedure” command from window 16 (and by naming it in its parameters),
or by selecting this procedure in window 16.

If the operator has completed all the test design work, the tool 1 automatically generates an exportable file translated into an appropriate language for the test bench used in the tests, for example one of the two available languages of the tool of FIG. 1, namely “ATEasy” and “LabVIEW”.

The diagram of FIG. 13 is a schematic illustration of the final steps of the design of test programs. Clicking on button 37 (screen view 38) for the conversion of programs opens a window 39 named “Convert”, which displays the various types of conversion available in the tool 1. In the present case, the line “Backup the [*.ACP]<—>Test program ATEasy® [*.PCT]” is selected, which launches the conversion of the test program designed in high-level language into a “low-level” language, and produces the code (40) of the test program in the ATEasy language, which can then be used by any appropriate test equipment, such as a PC 41.

In conclusion; the tool according to the invention enables documentation and code to be generated automatically (with a choice of the language used) from the data input by the user.

Owing to the automatic generation engines (as shown in FIGS. 2 to 5), it enables savings to be made in development time and consequently in costs.

The links and traceability (achieved by storing all the test requirements and the various test parameters and procedures in the tool 1), deployed through the various development phases, also make it possible to assure the quality of the end product.

The architecture of the tool, combined with the architecture of the development process; permits maximum reuse and does not become obsolete over time.

In an exemplary embodiment, the tool was developed using Excel initially, and then in C Sharp language.

It enables any test program specification operator to perform the following tasks:
the specification of his test requirements in a simple, structured way (by providing a test specification method: see FIGS. 2 to 7);
the automatic production and updating of the specification or design documents (by the provision of an automatic document generation engine: see FIGS. 8 and 9);
the automatic generation and updating of the test software in any language (by the provision of a library of commands and an automatic code generation engine: see FIGS. 10 to 13);
The transmission, throughout the development phases of operating system, of the essential data for supporting this system, thus greatly increasing the reuse rate. The data input into the tool are universal and therefore enduring throughout the phases of the service life of the support means,
the management, at low cost, of the software and hardware obsolescence which affect existing test benches.

This exemplary embodiment revealed the following:
a saving in development time in the various phases (specification, design, coding, documentation, changes, traceability, and the like),
a reduction in the development costs (by 15% to 20%),
the major assistance provided by this tool in gaining CMMI2 certification,
the readability of the resulting programs, with dear and comprehensible information (in high-level language, as specified above), which ensures their enduring usefulness.

Finally, a tool according to the invention is universal in the field of testing and measurement, and is not in any way dependent on an existing product.

A tool according to the invention is not a test sequencer.

However, as in any equipment test procedure, it identifies the architecture which must be used in order to obtain an end product, such as an automated test for equipment, development and validation documentation, or the like.

A tool according to the invention is enduring because it is not associated with a specific existing language or a specific equipment test application. A test sequencer, however, is associated with commercial applications which are proprietary in many cases, and thus runs a considerable risk of obsolescence and a lack of enduring usefulness.

A tool according to the invention is intended for use in testing equipment, but is not restricted to an existing test bench equipped with measuring instruments and loaded with an existing test application with or without an integrated sequencer. It is used on an ordinary PC. Its end products, namely its development, support and validation documentation and procedures for testing equipment, are totally independent of, and transferable to, any type of existing or future applications or languages. The independence of the end products enables the criteria of “universal” and “enduring” to be met.

The invention enables an equipment test procedure to be created according to the architecture required by any test program.

Advantageously, the invention enables the operator to design the various tasks and subtasks of his equipment test procedure independently of the test bench. The tool stores his procedure and enables this procedure to be exported to a suitably equipped test bench, regardless of the application, the sequencer used, or the code applied.

The invention enables the test procedure to be specified at the highest level. The most immediate effect is that it can produce a specification document or set of specifications which cover all the expected requirements of the equipment test, it can produce a test procedure and, subsequently, an equipment test program to be transferred to a test bench.

Depending on the data input by the tool, these specifications include, notably,
the requirements for the capacities of the end product: test program
the functions tested by the equipment test procedure
the independence of the sub-modules designed in this way
the requirements for internal and external interfaces with the output program
the requirements for dimensions and processing time the safety and security requirements
the design constraints
the specific performance levels related to the test program in the end product
the various operating modes concerned with the deployment of the procedure
the rates of coverage and rates of localization associated
and finally the detailed requirements for the tasks and items to be produced, providing the necessary contractual aspect of the development and validation of the end product.

The invention thus makes it possible to input all the requirements associated with the test procedure together with their traceability, at the same time as the input of the unit tests.

By engineering an equipment test procedure with no specific sequencer or test bench, the method according to the invention provides the ability to define the requirements of the scenarios of the test procedure to be produced, which is a novel feature in this field. These requirements input into the tool are independent of any test bench or any sequencer. It is this that gives the invention its distinctive nature and its universal applicability, and reveals an inventive step by comparison with products on the market at the present time. At present, commercial competition obliges manufacturers to offer proprietary products which are therefore competing and non-universal.

The invention provides a library of generic commands. This library constitutes an inventive step, again in terms of “universality and enduring usefulness”, with respect to the prior art, as the prior art provides no generic commands for specifying a user's own equipment test procedure in a universal way, but produces a low-level code directly according to predetermined test writing software in the field of instrumentation.

The invention is distinct from these prior art applications. The end product can subsequently be applied to any equipment test platform produced by any manufacturer. One of the objectives of the tool is, notably, the design of a test procedure architecture regardless of the platform to be used. At the present time, the choice of platform is a real problem for manufacturers. They are obliged to make a choice between the various available platforms, thus running the risk of suffering from subsequent obsolescence.

Furthermore, the tool's automatic generation of specification, development and validation documentation ensures the traceability and maintainability of the engineering of their equipment testing over time.

Thus a development operator can describe the operating mode for all the tests for his equipment for which the requirements have been formulated by using totally generic high-level commands which are not associated with any one language, and which are therefore enduring. These commands are supplied by a library of commands which is created for the tool and is unique in this field. These commands are also closer to a “test engineering” type of specification than to a data processing code for specialists.

By using a universal equipment testing procedure which is specified, designed and documented with the same tool, the invention makes it possible to export the final code and equipment test program to a language chosen subsequently, for operation on the desired platform.

Consequently there is no code to be produced by the user of the tool, by contrast with the prior art sequencers which are restricted to languages. The test specifier and/or designer no longer needs to be an experienced IT specialist but can be a technician or engineer skilled in operating the equipment to be tested.

A database coupled to the tool has the task of automatically generating the low-level code.

This has two advantages, namely:
no knowledge of information technology or of the equipment test oriented languages is required;
the test engineering can be transferred from one language to another present or future language, if the language and/or platform become obsolete.

A tool according to the invention thus automatically generates a file, according to the chosen language, which is directly executable on the destination test bench. In case of obsolescence of the environment, language, platform, test sequencer, or other element used, the tool can generate a new the in a different language from the same source.

The steps of the method according to the invention make it possible, notably, to describe the generic and enduring nature and the simple obsolescence management of engineering work carried out on the tool proposed by the invention. The invention is easily implemented on a simple. PC by a user without expert knowledge of software, whereas, in the existing solutions, it is necessary to choose and acquire a test platform, to have appropriate resources in the languages available on the market, and especially to have an expensive test bench available for the engineering and development work.

The universal aspect of a tool according to the invention is demonstrated by the fact that:
the engineering and development work is carried out without regard to any predetermined solutions,
the end products of the documentation type are universal, since they are not concerned with a proprietary platform or language, and are therefore totally enduring and transferable to different environments,
the end products of the equipment test procedure type are exportable, regardless of the code, to any type of application, owing to the generic/specific conversion databases of the tool.

By contrast with the prior art, the invention enables a test to be specified at the correct level of a specification, that is to say at high level, and not by writing the low-level output code directly.

The invention also makes it possible to generate automatically all the development, specification, design, test, validation and other documentation in the standard DOD XX industrial format, according to the data and the form of input required by the tool.

The invention provides, notably,
A complete engineering tool extending from the high-level specification of the test procedure to the production of all the development documents relating to the industrial development cycle, known as the “V” cycle, in a universal and therefore enduring language, designed to be transferable to any kind of existing or future equipment test language.
The resolution of the problems currently encountered by manufacturers who must reduce the development costs for testing the equipment that they produce. These manufacturers are faced with all the costs of the different development phases, namely:
the writing of the test specification by a specialist in the equipment to be tested,
the design of the test by a test and measurement specialist,
the coding by a specialist in the chosen test language,
the verification of the conformity and consistency of all these phases, by a quality specialist,
the tool is the first tool which covers all these phases, to provide the maximum optimization of the development and traceability of the changes,
the resolution of the problem of obsolescence encountered by manufacturers when platforms are obsolete or the test software used or the instrumentation is no longer in production, since the tool draws from, and operates on the basis of, the essence of the test, not the means chosen for implementing it.

At present, manufacturers must:
specify their tests at high level by writing a specification document,
instruct the test and measurement teams to design their tests in the language deployed in their company while ensuring the maintenance of the development capacity,
instruct these teams, or specialists in the code, to produce the automatic test program which will guide the instruments,
instruct all the participants to update and validate the test programs, which requires the reorganization of all the phases if changes are made,
tackle the problems of redeveloping some or all of the preceding phases if the language, the instrumentation or the equipment to be tested become obsolescent, resulting in a low rate of reuse and high and uncontrollable owning costs.

A tool according to the invention is for use by a specialist in the equipment to be tested. Consequently, the test documentation and procedure are entirely written in a totally generic form. The procedure enables the code to be generated in an existing or future test language which is chosen on an a posteriori basis. Any change in the resulting engineering is automatically allowed for by the tool and the documentation of the language.

In case of obsolescence, the manufacturer converts his test procedure to another language, without having to revise his engineering or the documentation which was produced.

1. A method of making an enduring universal tool for developing equipment tests using a test bench, implemented with a test development tool having including a computer, means of data input and display, and at least one memory, said method comprising the following steps:
an operator designs the various tasks and subtasks of the test program on a test bench which the tool stores in memory;
the operator uses said input means to input the specifications of the requirements of the test program;
the operator chooses the requirements of the scenario which is to be followed according to the test results;
if the operator has input the data for the tests, the tool automatically generates the documentation for the tests thus designed;
a development operator then describes the operating mode for each of the tests for which requirements have been formulated, using the commands provided by a library of generic commands for the tool;
the operator proceeds to design each elementary test; and
the tool automatically generates an exportable file translated into an appropriate language for the test bench used for the tests.

2. The method as claimed in claim 1, wherein the documentation produced by the tool includes at least one of the following elements: documentation on the specification of the software test requirements, this specification being in a specific format, documentation describing the test procedures designed with the aid of the tool, documentation describing the organization of the validation of the tests, and documentation for recording the results of this validation.

3. The method as claimed in claim 1, wherein, for each elementary test selected, the operator chooses the requirements of the scenario to be followed according to the test results.

4. The method as claimed in claim 3, wherein the requirements of the scenario to be followed include at least one skip to another task.

5. The method as claimed in claim 1, wherein the development operator calls routines stored in the tool when operations have to be repeated.

6. An enduring universal tool for developing equipment tests for the implementation of the method as claimed in claim 1, including a requirement specification function, a test design function, a library of generic commands, document generation engines and libraries to support the conversion of high-level test programs into low-level language.
